(19) United States
(12) Patent Application Publication
(10) Pub. No.: US 2024/0076534 A1
(43) Pub. Date: Mar. 7, 2024

(54) Multi-Purpose Compound

(71) Applicants: Charles Jerome Findley, Statenville, GA (US); Brad Steel Findley, Statenville, GA (US)

(72) Inventors: Charles Jerome Findley, Statenville, GA (US); Brad Steel Findley, Statenville, GA (US)

(21) Appl. No.: 18/079,839

(22) Filed: Dec. 12, 2022

Related U.S. Application Data
(60) Provisional application No. 63/288,517, filed on Dec. 10, 2021.

(51) Int. Cl. C09J 167/00; C04B 41/00; C09J 11/04

(52) U.S. Cl. CPC C09J 167/00; C04B 41/00; C09J 11/04; C08K 3/40

(57) ABSTRACT

A three-part combination of chemical products that is not only extremely strong, but extremely durable and easy to apply as an all-purpose adhesive capable of bonding numerous like and unlike materials together, including but not limited to wood, fabric, plastics, ceramics, concrete and metals. A further use of the same ingredients and proportions can be used in the production of highly durable and inexpensive molded or 3-D printed products. The combination can also be used to produce, using different proportions, non-shrinking fillers for automotive, construction, repair and the like.

### CROSS-REFERENCE TO RELATED APPLICATIONS

This application claims the benefit and priority of U.S. Provisional Application Ser. No. 63/288,517 titled “Multi-Purpose Compound and Uses Thereof” filed Dec. 10, 2021, the same being incorporated herein by reference.

### BACKGROUND OF THE INVENTION

### Field of the Invention

The instant invention pertains generally to chemical formulas and compounds used as glues and fillers for construction, repair and the like. More particularly, the instant invention is directed to a three-part combination of chemical products that has proved to be not only extremely strong, but extremely durable and easy to apply as an all-purpose adhesive capable of bonding numerous like and unlike materials together, including but not limited to wood, fabric, plastics, ceramics, concrete and metals. A further use of the same ingredient proportions can be used in the production of highly durable and inexpensive molded or 3-D printed products. The combination can also be used to produce, using different proportions, non-shrinking fillers that have proved to be invaluable in terms of this long-sought characteristic.

### Background and Relevant Art

Glues and adhesives for construction and manufacturing are well known in the arts of the invention, as are fillers for repair and touch-up work. Fillers also have a long history in the repair of vehicle bodies with long and extensive use in the fields of automotive body maintenance and repair. Such fillers allow sometimes extreme damage due to impacts, rust, or other causes to be removed and replaced with a compatible filler comprised of a compound or compounds specifically formulated for this purpose, which is used to replace the damaged portions of the body, smoothed and matched to the contours of the item being repaired, and finally painted so as to make the repaired portion indistinguishable from its surroundings. There are, likewise, fillers for use with different materials such as fiberglass, stone, cement and wood. However, all of these fillers tend to have a defect that compromises their performance, especially for long-term repairs: they tend to sometimes shrink in the short term and invariably shrink over long periods of time. This means that any repair made using such filler materials will ultimately fail to disguise the damaged areas it is meant to cover and be recognizable as a “patch job”—with such shrinkage often resulting in cracks and crevices between the portion repaired and the remainder of the repaired item and otherwise detracting from the appearance of the item or surface being repaired.

### Summary and Objects of the Invention

One purpose of the instant invention is the formulation and application of chemical combinations and compounds serving as multi-purpose adhesives for use in construction, repair and the like. More particularly, the instant invention is directed to a three-part combination of chemicals that produces a liquid adhesive that has proved to be not only extremely strong, but extremely durable and capable of bonding numerous like and unlike materials together, including but not limited to wood, fabric, ceramics, concrete, and metals. A second purpose uses the foregoing proportions to produce a liquid that can be easily poured into a mold to form a molded product. A third purpose, using different proportions of these chemicals is, produces novel fillers with non-shrink characteristics superior to any now in use with metal, wood, and other solid construction and manufacturing materials.

The combinations described use portions of two commonly available commercial products: 3M Platinum Plus® Filler and 3M Bondo® Fiberglass Resin (both having publicly available listed ingredients). (Under the Doctrine of Equivalents as well as for practical purposes, these can be replaced by their chemical and functional analogs, which are also widely available). These products have been found to have novel and non-obvious uses in synergistic combination for the purposes described herein. Further information relevant to the invention can best be understood by reference to the drawing figures and description that follow.

### BRIEF DESCRIPTION OF THE DRAWINGS

The invention itself, both as to its organization and method of operation, together with further object and advantages thereof, may best be understood by reference to the following description taken in connection with the accompanying drawings in which:

FIGS. 1 and 2 provide exemplary sets or series of figures wherein concrete surfaces are glued together in accordance with the teachings of the invention, illustrating in part the extreme adhesive qualities, strength and benefits of the invention.

FIG. 3 provides a set or series of figures wherein the adhesion of the concrete blocks of FIGS. 1 and 2 are subjected to a test to determined whether the adhesive bond between said blocks can be pulled apart via a “pull” test along their axis of connection, further illustrating the extreme adhesive qualities, strength and benefits of the invention.

FIGS. 4 and 5 provides an exemplary set or series of figures wherein pieces of angle iron are glued together in accordance with the teachings of the invention and subjected to a “pull” text, which did not succeed in separating said items and then further subjected to powder coating and baking at extreme temperatures to a perfect finish in accordance with the system of the invention, both tests further illustrating the durability and utility of the inventions extreme adhesive qualities, strengths and benefits.

FIG. 6 provides an exemplary figure wherein thin sheet metal plates are glued together in accordance with the teachings of the invention and subjected to a pull test, once again illustrating its extreme adhesive qualities, strengths and benefits.

FIG. 7 provides an exemplary set or series of figures wherein the compound and teachings of the invention are used to produce an extremely strong and durable molded figure, illustrating its usefulness for the production of molded pieces and 3-D printing of same.

FIG. 8 provides an exemplary set or series of figures wherein the molded figure produced in FIG. 7 is subjected to powder coating and baking at extreme temperatures to a perfect finish in accordance with the system of the invention, illustrating the durability and utility of molded figures produced in accordance with the teachings of the invention.

FIGS. 9 and 10 provide an exemplary set or series of figures wherein the compound and teachings of the invention are used in the repair of broken ceramic items, illustrating its extreme adhesive qualities and durability for such uses.

FIG. 11 provides an exemplary set or series of figures wherein sections of PVC are glued together in accordance with the teachings of the invention and separation attempted, illustrating its extreme adhesive qualities, strengths and benefits.

FIGS. 12 and 13 provide an exemplary set or series of figures comparative figures wherein the invention is used for automotive body work and subjected to powder coating and baking to 120 Degrees Fahrenheit without shrinkage, retaining a perfect bond and finish in accordance with the system of the invention, illustrating the durability and utility of the product for filler applications in accordance with the teachings of the invention.

### DESCRIPTION

This invention is based on proprietary combination of the parts of two commonly available commercial products or their chemical equivalents/analogs:
(1) 3M Platinum Plus® Filler (this product and its chemical equivalents and analogs being hereinafter referred to as “First Filler”). The First Filler comes with a hardener specific to its formulation, referred to as a catalyst; and
(2) 3M Bondo®) Fiberglass Resin (this product and its chemical equivalents and analogs being hereinafter referred to as “Second Filler”). The Second Filler also comes with its own resin hardening agent specific to its formulation.

Portions of these two products have been found to have novel and non-obvious uses in synergistic combination for the purposes described herein. First, as an extremely powerful glue or adhesive. An appropriate liquid consistency for said purpose can be achieved in accordance with the following proportions after thorough mixing: First Filler 230 grams to Second Filler 172 grams, producing approximately 1 pint for the purposes of the invention. (This combination can be stored and also used for molding purposes as subsequently described). Second, as an extremely durable non-shrink filler. An appropriate filler consistency for said purpose can be achieved in accordance with the following proportions after thorough mixing: First Filler 253 grams to Second Filler 118 grams, producing approximately 1 pint for the purposes of the invention. (This combination can also be stored).

However, the third ingredient, the resin hardener used with the Second Filler is only added and mixed in when a portion of one of the two combination fillers—First Filler and Second Filler—above is ready to be applied for the purposes stated. Typically, an amount, by weight, of about 2% of the weight of the combination filler being used is mixed into the combinations described immediately before applying the combination to a work-piece/workpieces, or using it for molding purposes. (The catalyst/hardener provided for the First Filler/3M Platinum Plus Filler® is not used).

The aforesaid combinations are claimed herein both for, respectively, general adhesive and filler usage in all applications as well as in the particular proportions and for the particular processes and uses illustrated and discussed in the examples provided hereinafter.

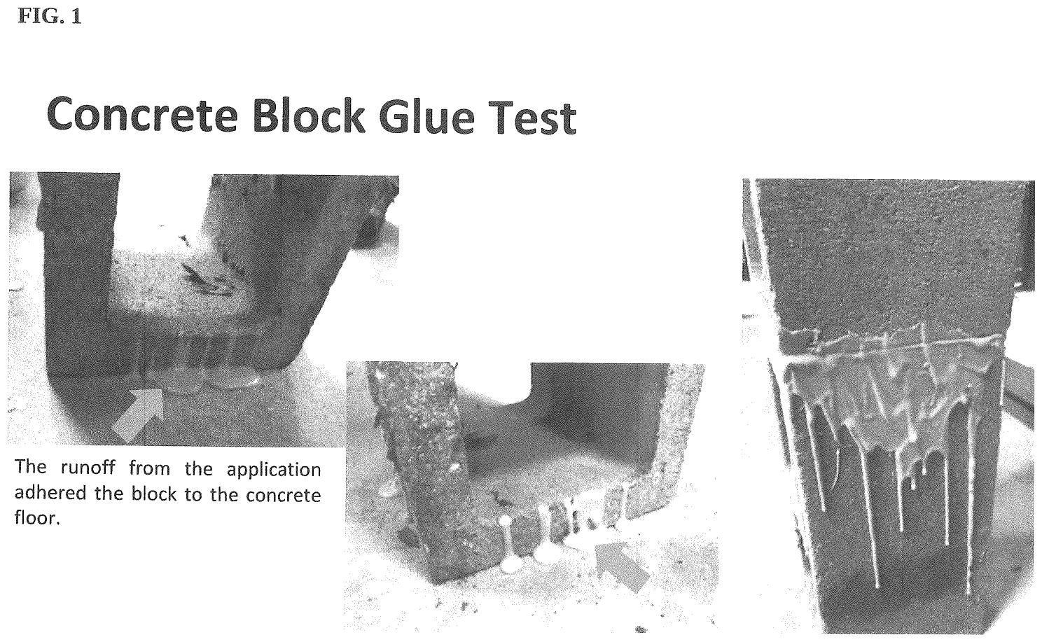

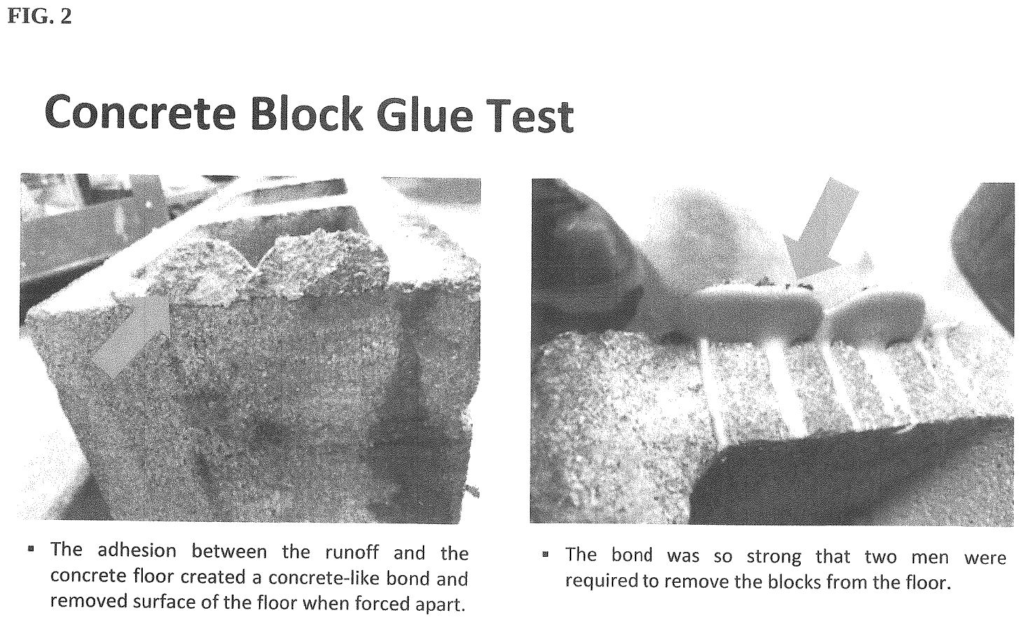

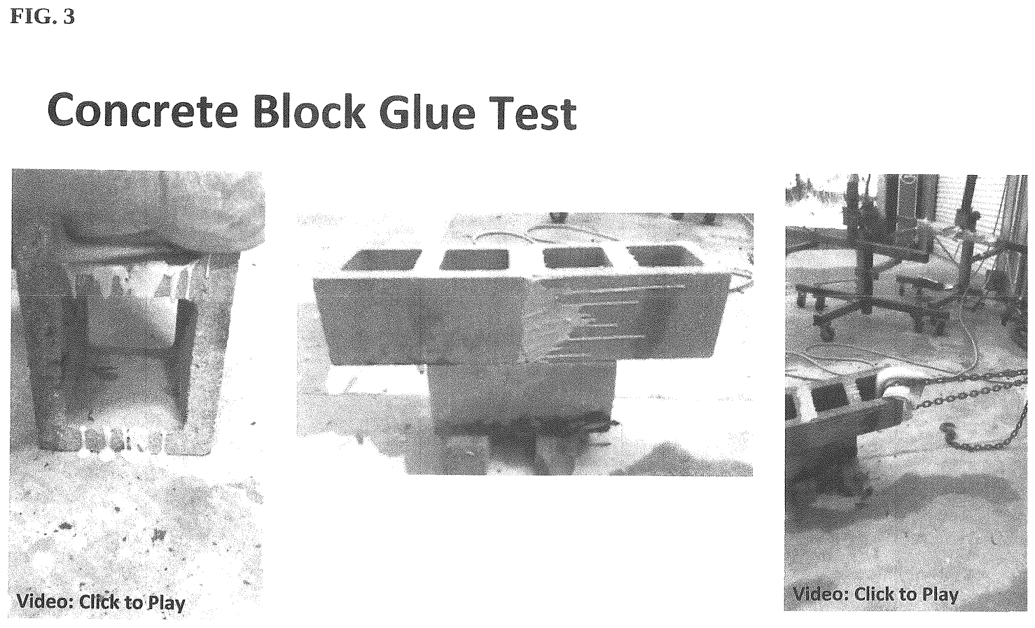

Example 1: Use of invention as Adhesive Binding Concrete and/or Cinderblock materials. FIGS. 1 through 3 provide exemplary sets or series of figures wherein concrete surfaces are glued together using the adhesive combination in accordance with the teachings of the invention, illustrating the extreme adhesive qualities, strength and benefits of the invention. FIG. 1 shows the adhesive applied between two blocks with some leaking over onto the floor. FIG. 2 illustrates the extreme adhesion provided as the leakage itself resulted in a bond requiring the full strength of two men to separate with resultant destructive results to part of the floor surface. FIG. 3 shows the blocks horizontally aligned for a pull test. Said test resulted in the destruction of the blocks without release of the bond between their bonded surfaces. Further “drop” tests resulted in the complete destruction of the blocks accept for the two bonded portions. (Further discussion is provided in association with said drawing figures).

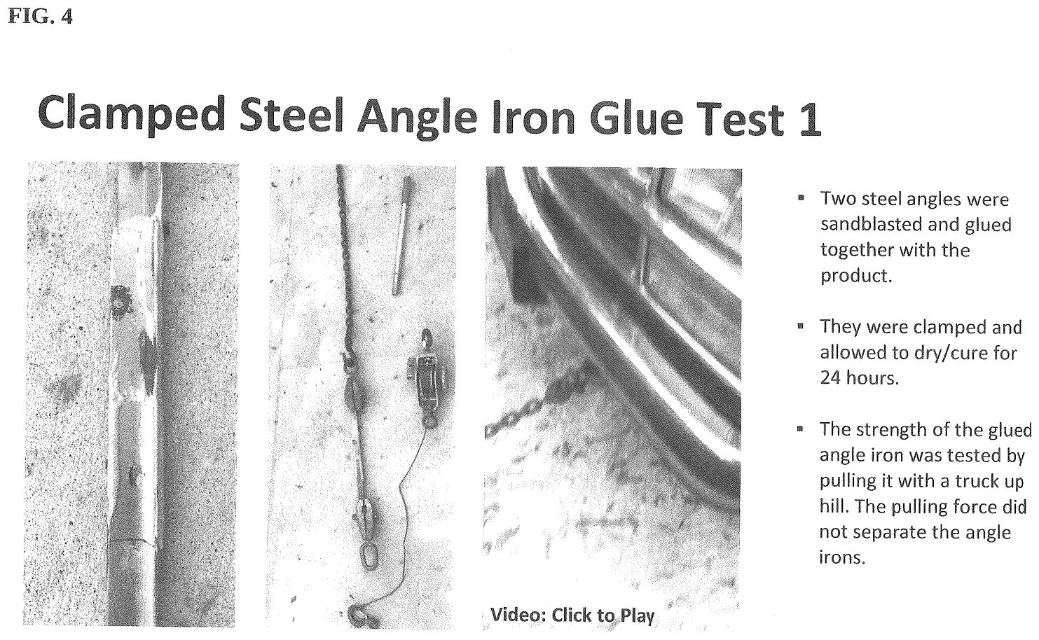

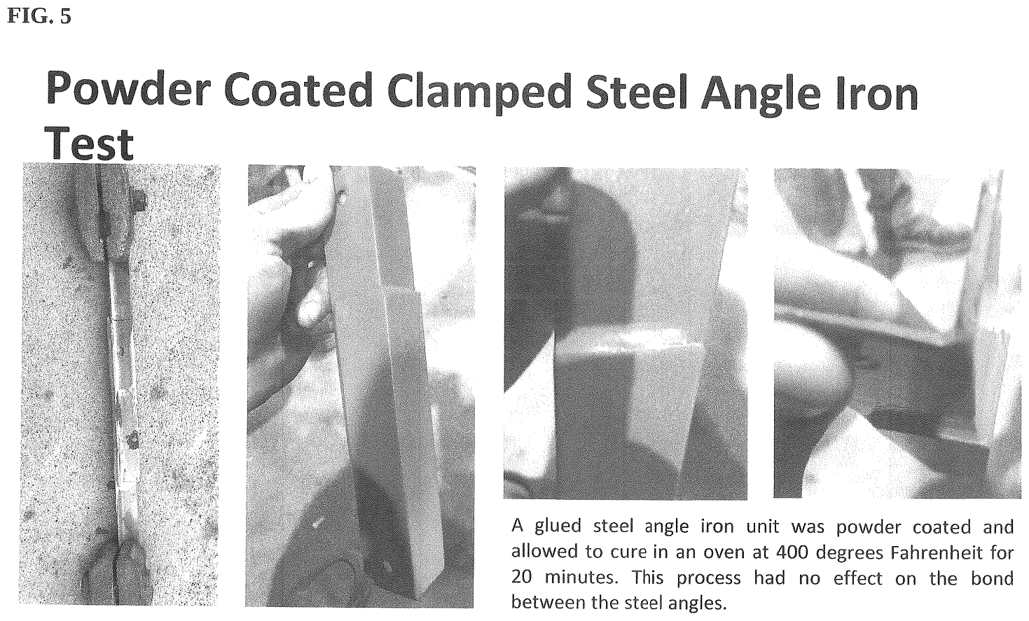

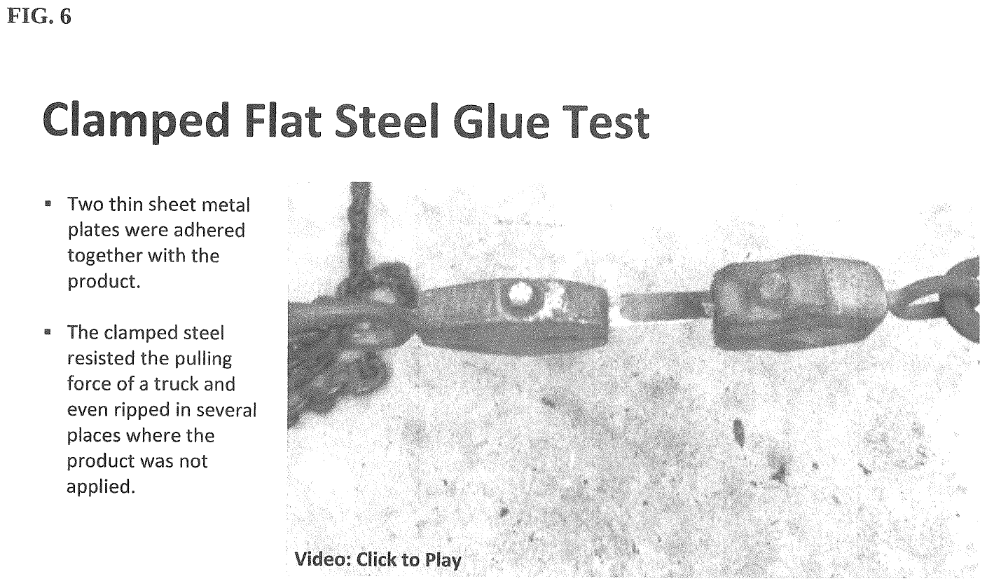

Example 2: Use of invention as Adhesive Binding Metal materials. FIGS. 4 and 5 provide a first exemplary set or series of figures wherein pieces of angle iron are glued together in accordance with the teachings of the invention, illustrating its extreme adhesive qualities, strengths and benefits. FIG. 4 provides an exemplary set or series of figures wherein the lengths of angle iron glued together and prepared for a pull test without separating. In FIG. 5 the two pieces are subjected to powder coating and baking at extreme temperatures to a perfect finish in accordance with the system of the invention, illustrating the durability and utility of its extreme adhesive qualities, strengths and benefits. FIG. 6 provides an exemplary set or series of figures wherein thin sheet metal plates are glued together in accordance with the teachings of the invention, and could not be separated, further illustrating its extreme adhesive qualities, strengths and benefits. (Further discussion is provided in association with said drawing figures).

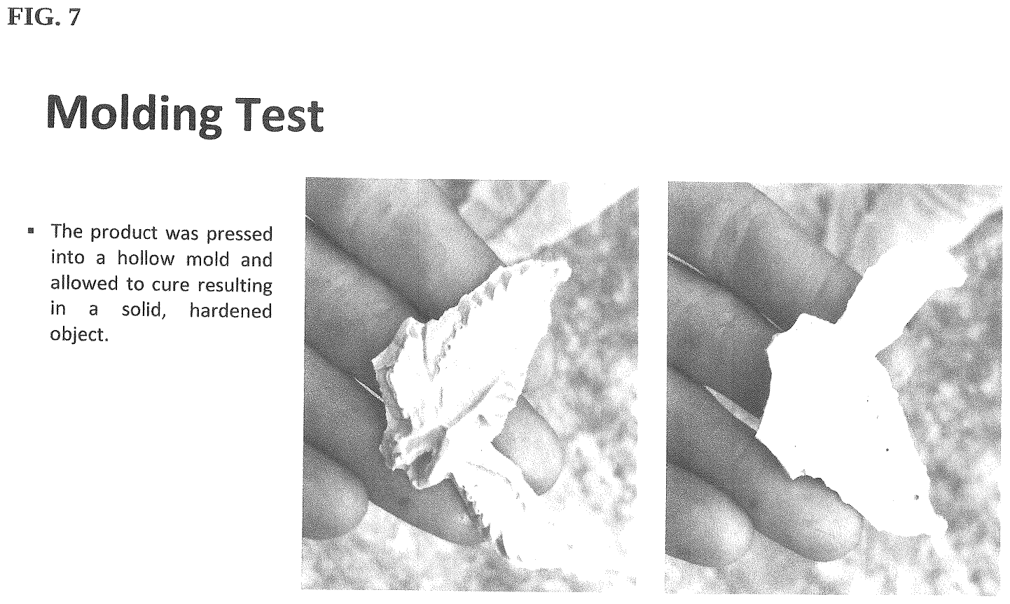

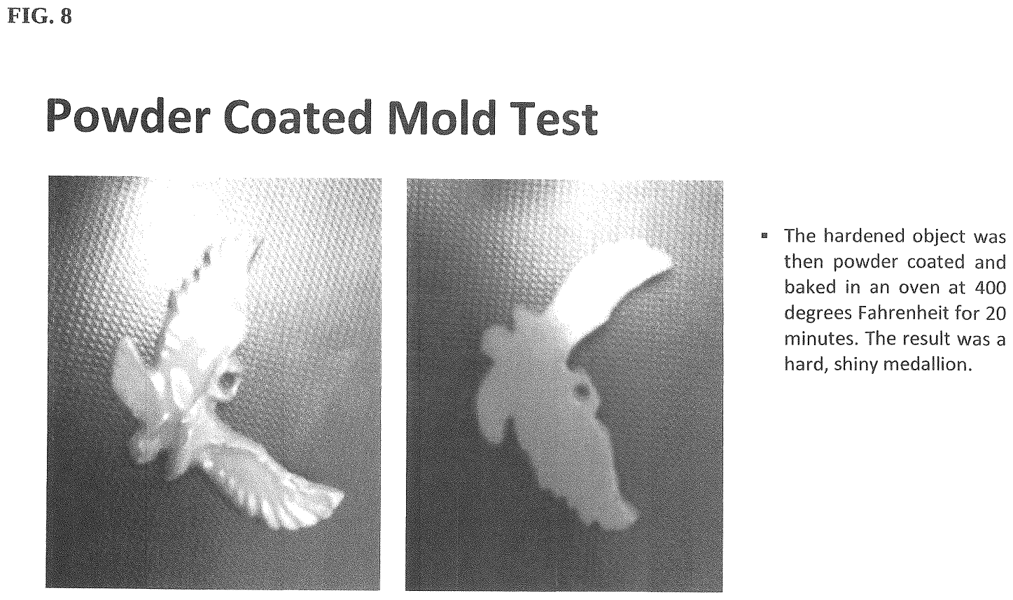

Example 3: Use of Invention for Molding Purposes. FIG. 7 provides an exemplary set or series of figures wherein the compound and teachings of the invention are used to produce an extremely strong and durable molded figure, illustrating its usefulness for the production of molded pieces and 3-D printing of same. FIG. 8 provides an exemplary set or series of figures wherein the molded figure produced in FIG. 8 is subjected to powder coating and baking at extreme temperatures to a perfect finish in accordance with the system of the invention, illustrating the durability and utility of molded figures produced in accordance with the teachings of the invention. (Further discussion is provided in association with said drawing figures).

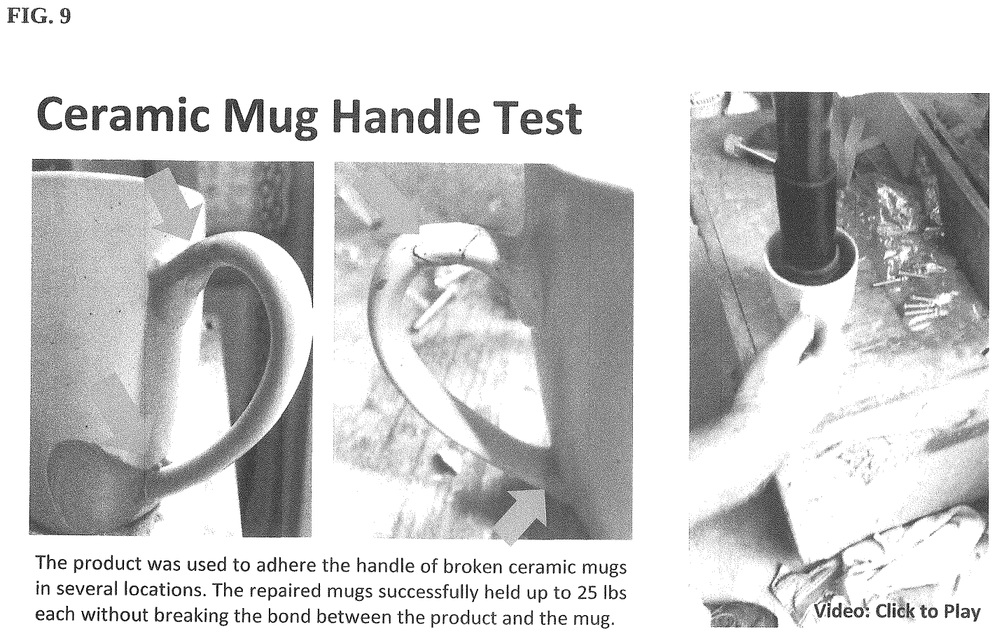

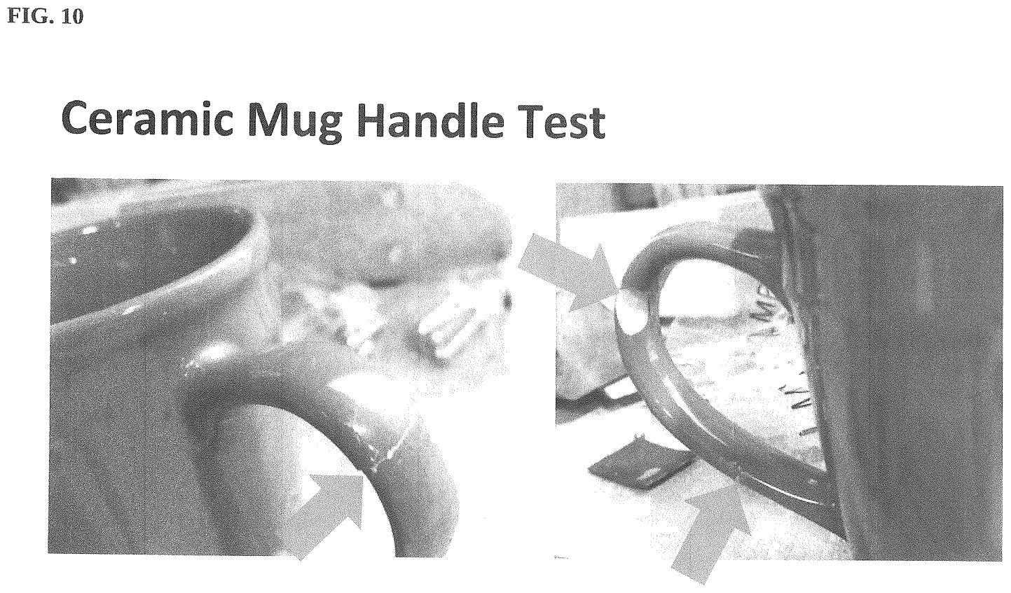

Example 4: Use of Invention as Adhesive for Ceramic Repair. FIGS. 9 and 10 provide an exemplary set or series of figures wherein the compound and teachings of the invention are used in the repair of broken ceramic items, illustrating its extreme adhesive qualities and durability for such uses. (Further discussion is provided in association with said drawing figures).

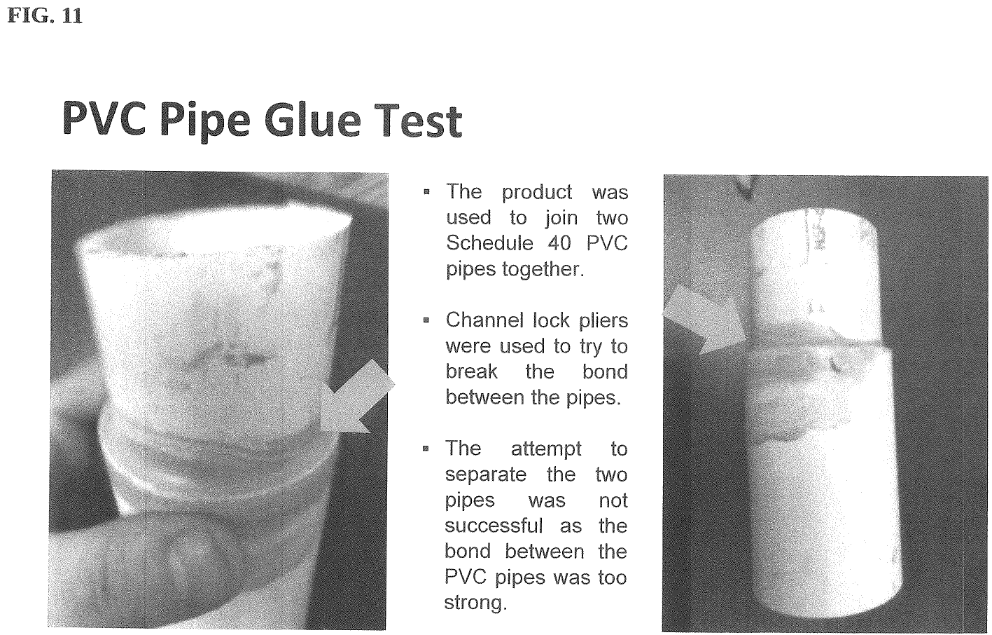

Example 5: Use of Invention as Adhesive Binding Plastic Materials. FIG. 11 provides an exemplary set or series of figures wherein sections of PVC are glued together in accordance with the teachings of the invention, illustrating its extreme adhesive qualities, strengths and benefits. (Further discussion is provided in association with said drawing figures).

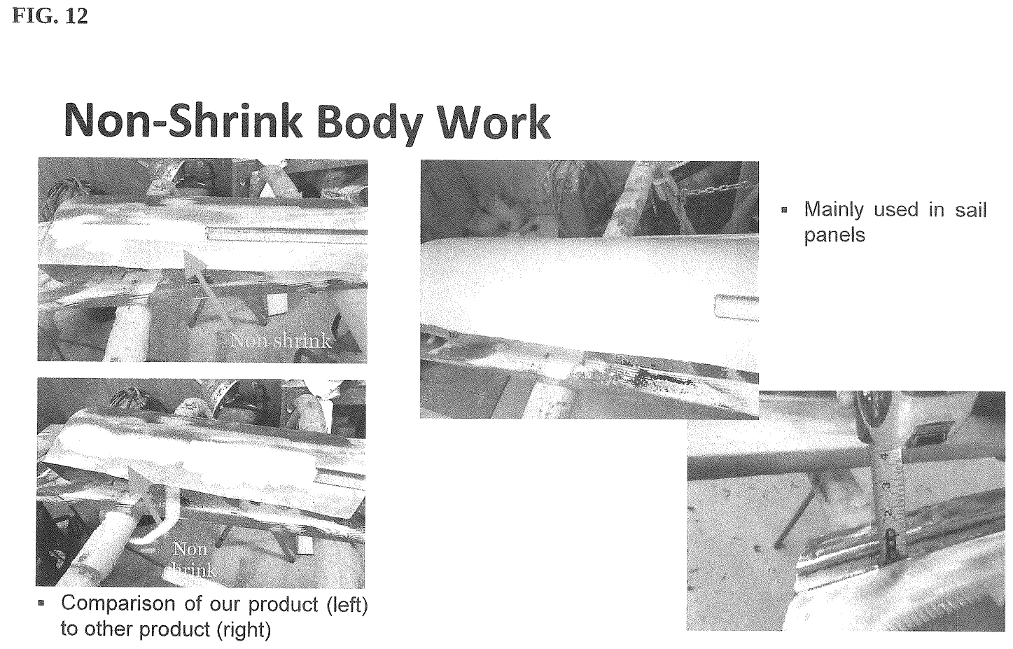

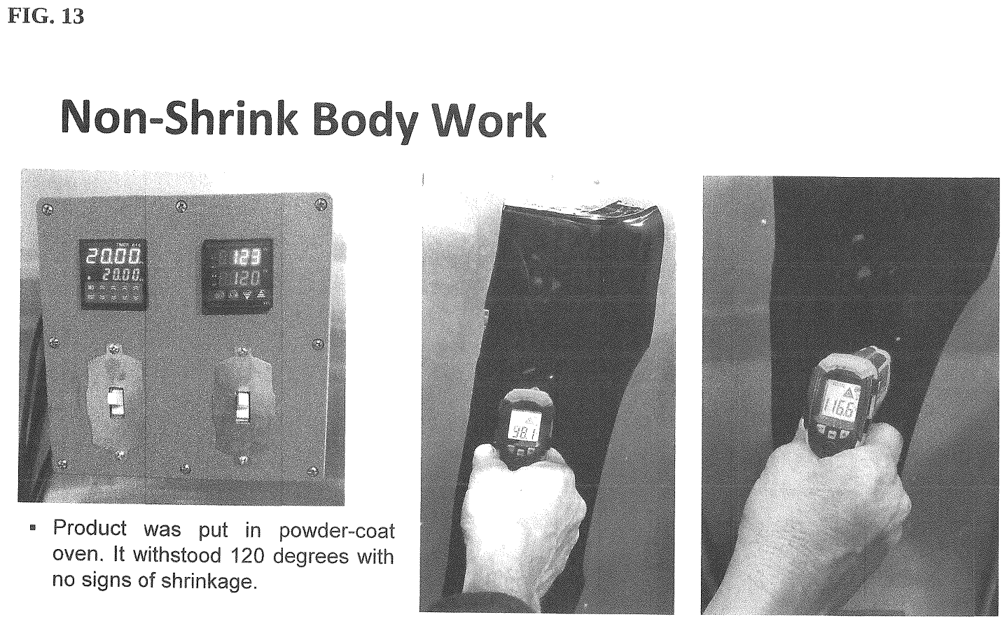

Example 6: Use of Invention as Filler for Automotive Body Repair. FIGS. 12 and 13 provide an exemplary set or series of figures wherein the invention is used for automotive body work and subjected to powder coating and baking to 120 Degrees Fahrenheit without shrinkage, retaining a perfect bond and finish in accordance with the system of the invention, illustrating the durability and utility of the product for filler applications in accordance with the teachings of the invention. (Further discussion is provided in association with said drawing figures).

In view of the foregoing, it should be clear that numerous changes and variations can be made without exceeding the scope of the inventive concept outlined. Accordingly, it is to be understood that the embodiment(s) of the invention herein described is/are merely illustrative of the application of the principles of the invention. Reference herein to details of the illustrated embodiment(s) is not intended to limit the scope of the claims, which recite those features regarded as essential to the invention.

1. A method for providing and using a multi-purpose composition, comprising
mixing First Filler with Second Filler to form a combination filler;
mixing said combination filler with a hardener suitable for use with said Second Filler to form an activated mixture;
applying said activated mixture as one of: a non-shrink filler to a work-piece, an adhesive between work-pieces, and a molding fluid in a mold; and
allowing said activated mixture to harden.

2. The method of claim 1, wherein said First Filler is mixed with said Second Filler in a 230 to 172 ratio by weight to form said adhesive.

3. The method of claim 1, wherein said First Filler is mixed with said Second Filler in a 230 to 172 ratio by weight to form said molding fluid.

4. The method of claim 1, wherein said First Filler is mixed with said Second Filler in a 253 to 118 ratio by weight to form said non-shrink filler.

5. The method of claim 1, wherein said hardener is mixed with said First Filler and Second Filler in a ratio of 0.02 to 1 by weight.

6. The method of claim 2, wherein said hardener is mixed with said First Filler and Second Filler in a ratio of 0.02 to 1 by weight.

7. The method of claim 3, wherein said hardener is mixed with said First Filler and Second Filler in a ratio of 0.02 to 1 by weight.

8. The method of claim 4, wherein said hardener is mixed with said First Filler and Second Filler in a ratio of 0.02 to 1 by weight.

9. The method of claim 1, further comprising at least one of powder coating and baking said hardened activated mixture.

10. The method of claim 2, further comprising at least one of powder coating and baking said hardened activated mixture.

11. The method of claim 3, further comprising at least one of powder coating and baking said hardened activated mixture.

12. The method of claim 4, further comprising at least one of powder coating and baking said hardened activated mixture.

13. The method of claim 5, further comprising at least one of powder coating and baking said hardened activated mixture.

14. The method of claim 6, further comprising at least one of powder coating and baking said hardened activated mixture.

15. The method of claim 7, further comprising at least one of powder coating and baking said hardened activated mixture.

16. The method of claim 8, further comprising at least one of powder coating and baking said hardened activated mixture.
